(19) United States
(12) Patent Application Publication
(10) Pub. No.: US 2015/0078446 A1
(43) Pub. Date: Mar. 19, 2015

(54) METHOD AND APPARATUS FOR INTER-LAYER INTRA PREDICTION

(71) Applicant: ELECTRONICS AND TELECOMMUNICATIONS RESEARCH INSTITUTE, Daejeon (KR)

(72) Inventors: Dong San Jun, Daejeon (KR); Jung Won Kang, Daejeon (KR); Ha Hyun Lee, Seoul (KR); Youn Hee Kim, Daejeon (KR); Soon Heung Jung, Daejeon (KR); Jin Soo Choi, Daejeon (KR); Jin Woong Kim, Daejeon (KR)

(21) Appl. No.: 14/387,454

(22) PCT Filed: Mar. 25, 2013
(86) PCT No.: PCT/KR2013/002460

§ 371 Date: Sep. 23, 2014

(30) Foreign Application Priority Data
Mar. 23, 2012 (KR) 10-2012-0029999

(51) Int. Cl. H04N 19/503; H04N 19/593

(52) U.S. Cl. CPC H04N 19/503; H04N 19/593
USPC 375/240.12

(57) ABSTRACT

The present invention relates to a method and an apparatus for inter-layer intra prediction. The method for inter-layer intra prediction comprises: a step of determining a reference layer for inter-layer intra prediction; a step of generating intra prediction information from the reference layer; and a step of performing inter-layer prediction on the current block based on the intra prediction information. In cases where the same location block of the reference block corresponding to the prediction object frame on a temporal axis is inter predicted in the reference layer, intra prediction information is generated based on the intra predicted same location block from among the previous and post frames of the reference frame.

### TECHNICAL FIELD

The present invention relates to the processing of video information and, more particularly, to a method and apparatus for performing inter-layer intra-prediction in Scalable Video Coding (hereinafter referred to as ‘SVC’).

### BACKGROUND ART

As broadcast having High Definition (HD) resolution is extended and served nationwide and worldwide, many users are being accustomed to images having high resolution and high picture quality. Accordingly, a lot of institutes are giving impetus to the development of the next-image device.

Furthermore, as there is a growing interest in Ultra High Definition (UHD) having resolution 4 times higher than HDTV along with HDTV, there is a need for technology in which an image having higher resolution and higher picture quality is compressed and processed.

In order to compress and process an image, inter-prediction technology in which a value of a pixel included in a current picture is predicted from temporally anterior and/or posterior pictures, intra-prediction technology in which a value of a pixel included in a current picture is predicted using information about a pixel included in the current picture, entropy encoding technology in which a short sign is assigned to a symbol having high frequency of appearance and a long sign is assigned to a symbol having low frequency of appearance, etc. can be used.

Video compression technology includes technology in which a constant network bandwidth is provided under a limited operating environment of hardware by not taking a flexible network environment into consideration. However, in order to compress video data applied to a network environment in which a bandwidth is frequently changed, new compression technology is required. To this end, a scalable video encoding/decoding method can be used.

### DISCLOSURE

### Technical Problem

The present invention proposes a method capable of performing inter-layer intra-prediction using intra-prediction information about neighbor blocks although a corresponding reference layer has been subject to inter-prediction when a single loop decoding mode is used in Scalable Video Coding (SVC).

### Technical Solution

(1) An embodiment of the present invention relates to an inter-layer intra-prediction method according to a single loop decoding mode, including the steps of determining a reference layer for inter-layer intra-prediction, generating intra-prediction information from the reference layer, and performing inter-layer prediction on a current block based on the intra-prediction information. If the co-located block of a reference frame corresponding to a target prediction frame in the reference layer on a time axis has been inter-predicted, the intra-prediction information may be generated based on an intra-predicted and co-located block, from among frames anterior and posterior to the reference frame.

(2) in (1), if a candidate layer that can be referred for the inter-layer intra-prediction is one or more and a co-located block in the candidate layer has been inter-predicted, the intra-prediction information may be generated from the intra-predicted and co-located block, from among the frame anterior and posterior to a frame in which the co-located block is present on the candidate layer.

(3) in (1), if a candidate layer that can be referred for the inter-layer intra-prediction is plural, the intra-prediction information may be generated from an intra-predicted block from among co-located blocks in the candidate layers.

(4) in (3), if a plurality of intra-predicted blocks is included in the co-located blocks of the candidate layers, a candidate layer of the highest layer may be selected as the reference layer, and

the intra-prediction information may be generated from an intra-predicted and co-located block in the selected reference layer.

(5) in (1), if a plurality of intra-predicted and co-located blocks is included in frames anterior and posterior to a frame to which a reference block belongs, the intra-prediction information may be generated from a co-located block having a minimum Rate-Distortion (RD) cost.

(6) in (1), the intra-prediction information may be generated from a co-located block having a minimum RD cost, from among the first co-located block of a first frame that is temporally anterior to a frame to which a reference block belongs and has been intra-prediction, the second co-located block of a second frame that is temporally posterior to the frame to which the reference block belongs and has been intra-predicted, and a third co-located block obtained by averaging image values of the first co-located block and the second co-located block.

(7) in (1), the intra-prediction information may be obtained from a co-located block having a minimum RD cost, from among the first co-located block of a first frame that is temporally anterior to a frame to which a reference block belongs and has been intra-prediction, the second co-located block of a second frame that is temporally posterior to the frame to which the reference block belongs and has been intra-predicted, and a third co-located block generated by interpolation based on the first co-located block and the second co-located block.

(8) Another embodiment of the present invention relates to an inter-layer intra-prediction apparatus according to a single loop decoding mode, including a layer determination module determining a reference layer for inter-layer intra-prediction, a prediction information generation module generating intra-prediction information from the reference layer, and an intra-prediction module performing inter-layer prediction on a current block based on the intra-prediction information. If the co-located block of a reference frame corresponding to a target prediction frame in the reference layer on a time axis has been inter-predicted, the prediction information generation module may generate the intra-prediction information based on an intra-predicted and co-located block, from among frames anterior and posterior to the reference frame.

(9) in (8), if a candidate layer that can be referred for the inter-layer intra-prediction is one or more and a co-located block in the candidate layer has been inter-predicted, the prediction information generation module may generate the intra-prediction information from the intra-predicted and co-located block, from among the frame anterior and posterior to a frame in which the co-located block is present on the candidate layer.

(10) in (8), if a candidate layer that can be referred for the inter-layer intra-prediction is plural, the prediction information generation module may generate the intra-prediction information from an intra-predicted block from among co-located blocks in the candidate layers.

(11) in (10), if a plurality of intra-predicted blocks is included in the co-located blocks of the candidate layers, the layer determination module may select a candidate layer of the highest layer as the reference layer, and the prediction information generation module may generate the intra-prediction information from an intra-predicted and co-located block in the selected reference layer.

(12) in (8), if a plurality of intra-predicted and co-located blocks is included in frames anterior and posterior to a frame to which a reference block belongs, the prediction information generation module may generate the intra-prediction information from a co-located block having a minimum Rate-Distortion (RD) cost. (13) in (8), the prediction information generation module may generate the intra-prediction information from a co-located block having a minimum RD cost, from among the first co-located block of a first frame that is temporally anterior to a frame to which a reference block belongs and has been intra-prediction, the second co-located block of a second frame that is temporally posterior to the frame to which the reference block belongs and has been intra-predicted, and a third co-located block obtained by averaging image values of the first co-located block and the second co-located block.

(14) in (8), the prediction information generation module may derive the intra-prediction information from a co-located block having a minimum RD cost, from among the first co-located block of a first frame that is temporally anterior to a frame to which a reference block belongs and has been intra-prediction, the second co-located block of a second frame that is temporally posterior to the frame to which the reference block belongs and has been intra-predicted, and a third co-located block generated by interpolation based on the first co-located block and the second co-located block.

### Advantageous Effects

In accordance with the present invention, inter-layer intra-prediction can be performed using intra-prediction information about neighbor blocks although a corresponding reference layer has been subject to inter-prediction when a single loop decoding mode is used in Scalable Video Coding (SVC). Accordingly, video encoding efficiency can be greatly improved.

### BRIEF DESCRIPTION OF THE DRAWINGS

FIG. 1 is a block diagram showing a construction according to an embodiment of a video encoder.

FIG. 2 is a block diagram showing a construction according to an embodiment of a video decoder.

FIG. 3 is a diagram schematically illustrating an example of an encoder using SVC.

FIG. 4 is a diagram schematically illustrating an example of a decoder using SVC.

FIGS. 5 to 7 are diagrams schematically illustrating contents in which inter-layer prediction is performed in accordance with the present invention.

FIG. 8 is a flowchart schematically illustrating a method of performing inter-layer intra-prediction in accordance with the present invention.

FIG. 9 is a block diagram schematically illustrating the construction of a prediction apparatus for performing inter-layer intra-prediction in accordance with the present invention.

### MODE FOR INVENTION

Hereinafter, embodiments of the present invention are described in detail with reference to the accompanying drawings. In describing the embodiments of the present invention, a detailed description of related known elements or functions will be omitted if it is deemed to make the gist of the present invention unnecessarily vague.

In this specification, when it is said that one element is ‘connected’ or ‘coupled’ with the other element, it may mean that the one element may be directly connected or coupled with the other element and a third element may be ‘connected’ or ‘coupled’ between the two elements. Furthermore, in this specification, when it is said that a specific element is ‘included’, it may mean that elements other than the specific element are not excluded and that additional elements may be included in the embodiments of the present invention or the scope of the technical spirit of the present invention.

Terms, such as the first and the second, may be used to describe various elements, but the elements are not restricted by the terms. The terms are used to only distinguish one element from the other element. For example, a first element may be named a second element without departing from the scope of the present invention. Likewise, a second element may be named a first element.

Furthermore, element modules described in the embodiments of the present invention are independently shown in order to indicate different and characteristic functions, and it does not mean that each of the element modules is formed of a piece of separated hardware or a piece of software. That is, the element modules are arranged and included, for convenience of description, and at least two of the element units may form one element unit or one element may be divided into a plurality of element units and the plurality of element units may perform functions. An embodiment into which the elements are integrated or an embodiment from which some elements are separated is included in the scope of the present invention unless it does not depart from the essence of the present invention.

Furthermore, in the present invention, some elements are not essential elements for performing essential functions, but may be optional elements for improving only performance. The present invention may be implemented using only essential elements for implementing the essence of the present invention other than elements used to improve only performance, and a structure including only essential elements other than optional elements used to improve only performance is included in the scope of the present invention.

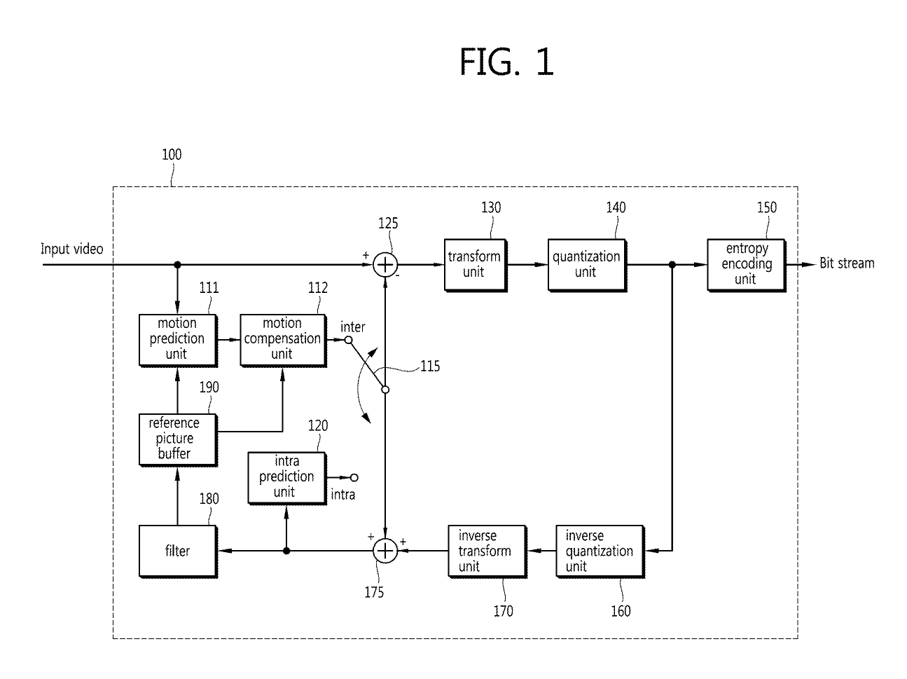

FIG. 1 is a block diagram showing a construction according to an embodiment of a video encoder.

Referring to FIG. 1, the video encoder 100 includes a motion prediction unit 111, a motion compensation unit 112, an intra-prediction unit 120, a switch 115, a subtractor 125, a transform unit 130, a quantization unit 140, an entropy encoding unit 150, an dequantization unit 160, an inverse transform unit 170, an adder 175, a filter unit 180, and a reference video buffer 190.

The video encoder 100 can perform encoding on an input video in intra-mode or inter-mode and output a bit stream. In the case of intra-mode, the switch 115 is switched to intra. In the case of inter-mode, the switch 115 is switched to inter. The video encoder 100 can generated a prediction block for the input block of the input video and then encode a difference between the input block and the prediction block.

In the case of intra-mode, the intra-prediction unit 120 can generate the prediction block by performing spatial prediction using a value of the pixel of an already encoded block neighboring a current block.

In the case of inter-mode, the motion prediction module 111 can obtain a motion vector by searching a reference picture, stored in the reference video buffer 190, for a region that is most well matched with the input block in a motion prediction process. The motion compensation module 112 can generate the prediction block by performing motion compensation using the motion vector and the reference picture stored in the reference video buffer 190.

The subtractor 125 can generate a residual block based on the difference between the input block and the generated prediction block. The transform module 130 can perform transform on the residual block and output a transform coefficient according to the transformed block. Furthermore, the quantization module 140 can quantize the received transform coefficient according to a quantization parameter and output a quantized coefficient.

The entropy encoding module 150 can perform entropy encoding on a symbol according to a probability distribution based on values calculated by the quantization module 140, an encoding parameter value calculated in an encoding process, etc. and output the bit stream according to the entropy-coded symbol. An entropy encoding method is a method of receiving a symbol having various values and representing the symbol in a string of binary numbers that can be decoded while removing statistical redundancy.

Here, the symbol mans a syntax element to be encoded/decoded, an encoding parameter, a value of a residual signal, etc. The residual signal may be called a residual block in a block unit.

If entropy encoding is applied, the size of a bit stream for a symbol to be encoded can be reduced because the symbol is represented by allocating a small number of bits to a symbol having a high incidence and a large number of bits to a symbol having a low incidence. Accordingly, the compression performance of video encoding can be improved through entropy encoding.

For entropy encoding, such encoding methods as exponential Golomb, Context-Adaptive Binary Arithmetic Coding (CABAC), and Context-Adaptive Binary Arithmetic Coding (CABAC) may be used. For example, the entropy encoding module 150 can store a table for performing entropy encoding, such as a Variable Length Coding/Code (VLC) table, and the entropy encoding module 150 can perform entropy encoding using the stored VLC table. Furthermore, the entropy encoding module 150 may perform entropy encoding using a method of binarizing a target symbol, a method of deriving and binarizing a probability model of a target symbol/bin, or a probability model.

The quantized coefficient can be inversely quantized by the dequantization module 160 and can be inversely transformed by the inverse transform module 170. The inversely quantized and inversely transformed coefficient can be added to the prediction block through the adder 175, thereby being capable of generating a reconstruction block.

The reconstruction block experiences the filter module 180, and the filter module 180 can apply one or more of a deblocking filter, a Sample Adaptive Offset (SAO), and an Adaptive Loop Filter (ALF) to the reconstruction block or the reconstruction picture. The reconstruction block that has experienced the filter module 180 can be stored in the reference video buffer 190.

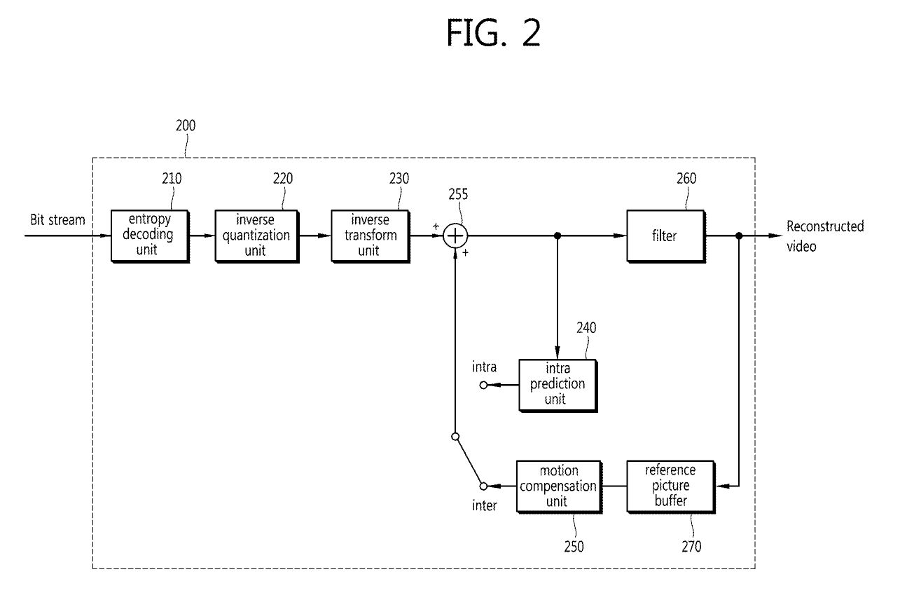

FIG. 2 is a block diagram showing a construction according to an embodiment of a video decoder.

Referring to FIG. 2, the video decoder 200 includes an entropy decoding module 210, an dequantization module 220, an inverse transform module 230, an intra-prediction module 240, a motion compensation module 250, a filter module 260, and a reference video buffer 270.

The video decoder 200 can receive a bit stream outputted from an encoder, perform decoding on the bit stream in intra-mode or inter-mode, and output a reconstructed video, that is, a restored video. In the case of intra-mode, a switch can be switched to intra. In the case of inter-mode, the switch can be switched to inter. The video decoder 200 can obtain a reconstructed residual block from the received bit stream, generate a prediction block, and generate a reconstructed block, that is, a reconstruction block by adding the reconstructed residual block to the prediction block.

The entropy decoding module 210 can generate symbols including a symbol having a quantized coefficient form by performing entropy decoding on the received bit stream according to a probability distribution.

If an entropy decoding method is applied, the size of a bit stream for each symbol can be reduced because the symbol is represented by allocating a small number of bits to a symbol having a high incidence and a large number of bits to a symbol having a low incidence.

The quantized coefficient is inversely quantized by the dequantization module 220 and is inversely transformed by the inverse transform module 230. After the quantized coefficient is inversely quantized/inversely transformed, a reconstructed residual block can be generated.

In the case of intra-mode, the intra-prediction module 240 can generate the prediction block by performing spatial prediction using a value of the pixel of an already encoded block neighboring a current block. In the case of inter-mode, the motion compensation module 250 can generate the prediction block by performing motion compensation using a motion vector and a reference picture stored in the reference video buffer 270.

The reconstructed residual block and the prediction block are added together by an adder 255. The added block experiences the filter module 260. The filter module 260 can apply at least one of a deblocking filter, an SAO, and an ALF to the reconstruction block or the reconstructed picture. The filter module 260 outputs a reconstructed video, that is, a restored video. The reconstructed video can be stored in the reference video buffer 270 and can be used for inter-frame prediction.

Meanwhile, with the development of communication and image technologies, various devices using image information are being used with different functions. Devices, such as a mobile phone, play moving images having relatively low resolution based on a bit stream, and devices, such as a Personal Computer (PC), play moving images having relatively high resolution.

Accordingly, a method for providing optimum moving image service to devices having different performance needs to be taken into consideration. One of solutions of the method is Scalable Video Coding (hereinafter referred to as ‘SVC’).

In general, if a sub-bit stream capable of playing a valid video image can be constructed in a target video codec after removing some of a video bit stream, the video bit stream can be said to be scalable. Here, the sub-bit stream is a basic stream for corresponding content, and an image having lower quality than an image reconstructed by the original bit stream can be reconstructed by the sub-bit stream.

The common type of scalability includes temporal, spatial, and quality types. From among the types, temporal scalability is scalability regarding a frame rate, and spatial scalability is scalability regarding a picture size or resolution. Furthermore, quality scalability can be said to be related to the fidelity of an image.

Single layer encoding means the encoding of a video sequence that does not provide a scalability function. In contrast, multi-layer encoding provides scalability by encoding a video sequence having multiple layers.

In a spatial scalable system, video data having the lowest resolution is also called a base layer. Furthermore, video data having higher resolution is also called an enhancement layer.

A method of determining or predicting the data value of an enhancement layer is also called inter-layer prediction. Here, a layer on which prediction is performed is called a reference layer. Inter-prediction or intra-prediction can also be applied to inter-layer prediction. The inter-layer inter-prediction means that prediction is temporally performed between different pictures in the same resolution layer, and inter-layer intra-prediction means that prediction is spatially performed within the same picture of a specific resolution layer.

In the inter-layer prediction, information about an enhancement layer is predicted by utilizing information about a lower layer, such as a base layer, to the highest degree. Accordingly, the amount of information transmitted or processed in order to predict the enhancement layer can be greatly reduced. Reconstructed information about a lower layer is up-sampled and used to reconstruct information about a high layer, for example, an enhancement layer.

SVC inter-layer prediction includes motion prediction and residual prediction.

In inter-layer motion prediction, the block of a current layer can be predicted with reference to an intra-predicted block within a reference layer according to inter-layer intra-prediction. In the case of inter-layer intra-prediction, if a layer to be referred for the prediction of a current layer is encoded through intra-prediction and the layer has a reconstructed video (or block) in an encoding/decoding process, inter-layer inter-prediction can be performed using the corresponding block.

If a block to be referred in a reference layer has been subject to inter-encoding, the block of a current layer can be predicted according to inter-layer inter-prediction.

In the case of inter-layer residual prediction, a residual block corresponding to a reference layer can be up-sampled and can be used as a residual block for the block of a current layer.

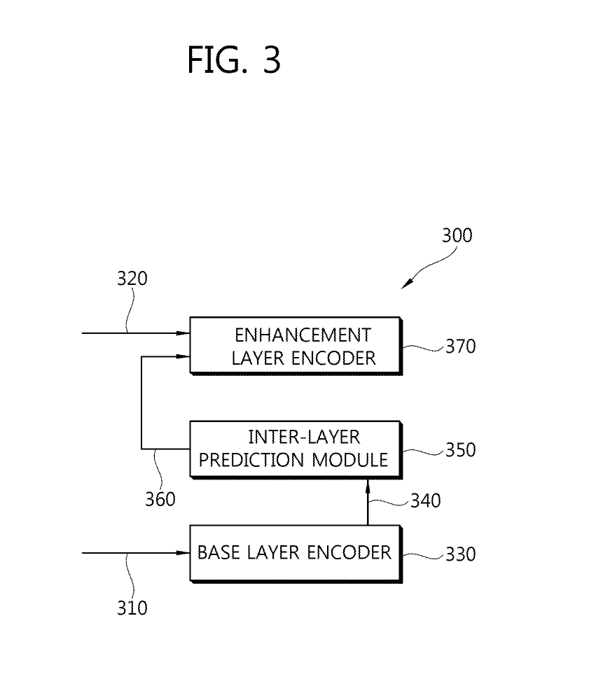

FIG. 3 is a diagram schematically illustrating an example of an encoder using SVC. Referring to FIG. 3, the SVC encoder 300 including a base layer encoder 330, an inter-layer prediction module 350, and an enhancement layer encoder 370.

Video streams 310 and 320 for the encoding of a corresponding layer are inputted to the base layer encoder 330 and the enhancement layer encoder 370. The video stream 310 having low resolution is inputted to the base layer encoder 330, and the video stream 320 having high resolution is inputted to the enhancement layer encoder 370.

The base layer encoder 330, as described with reference to FIG. 1, can perform encoding on a base layer. Information about the encoding performed by the base layer encoder 330 is transferred (340) to the inter-layer prediction module 350.

As described above, the inter-layer prediction module 350 can up-sample information about a video that has been reconstructed by the base layer encoder 330 and transfer (360) the up-sampled information to the enhancement layer encoder 370. Here, the inter-layer prediction module 350 may perform deblocking filtering on the video reconstructed by the base layer encoder 330 and transfer the resulting video to the enhancement layer encoder 370.

The information about the base layer transferred through the inter-layer prediction module 350 may be a pixel value to be used in intra-prediction if a block referred in the base layer has been subject to intra-prediction and may be motion information and residual information to be used in inter-prediction if a block referred in the base layer has been subject to inter-prediction.

The enhancement layer encoder 370 can perform encoding on an enhancement layer based on the information about the base layer that has been transferred by the inter-layer prediction module 350 and the information about a video sequence having high resolution.

Up-sampling based on the information about the base layer may be performed by the enhancement layer encoder 370 or may be performed by the inter-layer prediction module 350.

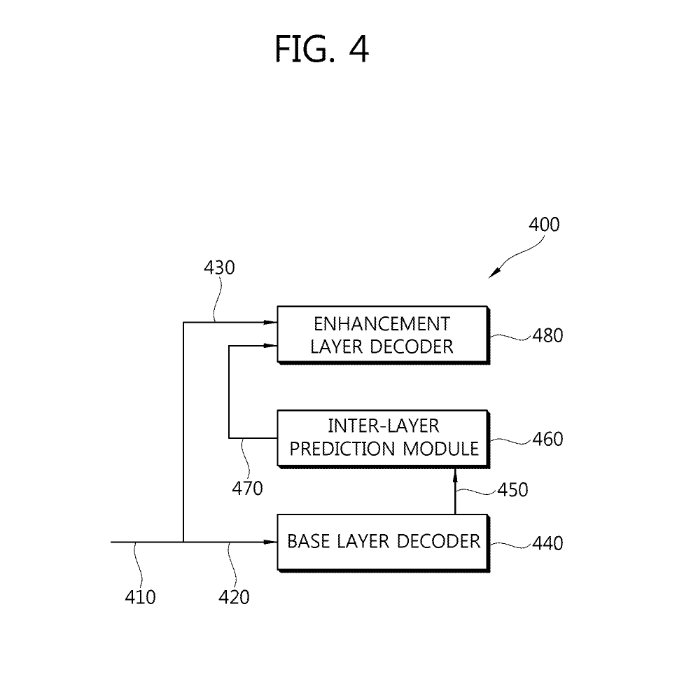

FIG. 4 is a diagram schematically illustrating an example of a decoder using SVC. Referring to FIG. 4, the SVC decoder 400 includes a base layer decoder 440, an inter-layer prediction module 460, and an enhancement layer decoder 480.

A bit stream 410 transmitted by an encoder includes a bit stream 420 including information about a video having low resolution that is a bit stream for the base layer decoder 440 and a bit stream 430 including information about a video having high resolution that is a bit stream for the enhancement layer decoder 480.

The bit streams 420 and 430 for the decoding of a corresponding layer are inputted to the base layer decoder 440 and the enhancement layer decoder 480, respectively. That is, the bit stream 430 for the video having low resolution is inputted to the base layer decoder 440, and the bit stream 430 for the video having high resolution is inputted to the enhancement layer decoder 480.

The base layer decoder 440, as described with reference to FIG. 2, can perform encoding on a base layer. Information about a video in the base layer that has been reconstructed by the base layer decoder 440 is transferred (450) to the inter-layer prediction module 460.

As described above, the inter-layer prediction module 460 can up-sample the video reconstructed by the base layer decoder 440 and transfer (470) the up-sampled video to the enhancement layer decoder 480. Here, the inter-layer prediction module 460 may perform deblocking filtering on the video reconstructed by the base layer decoder 440 and transfer the resulting video to the enhancement layer decoder 480.

The information about the base layer transferred through the inter-layer prediction module 460 may be a pixel value to be used in intra-prediction if a block referred in the base layer has been subject to intra-prediction and may be motion information and residual information to be used in inter-prediction if a block referred in the base layer has been subject to inter-prediction.

The enhancement layer decoder 480 can perform decoding on an enhancement layer based on the information about the base layer that has been transferred by the inter-layer prediction module 460 and the information about the video sequence having high resolution.

Up-sampling based on the information about the base layer may be performed by the enhancement layer decoder 480 and may be performed by the inter-layer prediction module 460.

FIGS. 3 and 4 illustrate the examples in which a layer includes two layers; a base layer and an enhancement layer. The method and apparatus described in this specification, however, are not limited to the examples. The method and apparatus may be applied to a case where an enhancement layer includes a plurality of layers; a high layer and a low layer. In this case, an encoder and a decoder for the high layer can perform encoding and decoding on the high layer based on information about the low layer.

Meanwhile, in SVC, a single loop decoding mode and a multi-loop decoding mode can be used.

In multi-loop decoding, decoding is fully performed on each of layers of a picture having low resolution, and inter-layer intra-prediction is then performed on the layers of a picture having high resolution. In this case, images having high resolution can be up-sampled using images having low resolution on the pyramids of the images ranging from low resolution to high resolution.

In contrast, in single loop decoding, in order to reduce the complexity of an encoding/decoding process, motion compensation is performed on resolution on which decoding will be performed Accordingly, all the processes of motion compensation are performed on only one resolution (target resolution) even though the picture of any layer is reconstructed. In single loop decoding, motion information, mode information, and residual information obtained from a layer having low resolution are used for decoding on a layer having next high-level resolution. That is, decoding can be performed on a layer having next resolution based on information about the decoding of a layer having low resolution, and decoding can be performed on a layer having higher resolution based on information obtained through the decoding.

In multi-loop decoding, the image value of a pixel value can be reconstructed both in inter-layer inter-prediction and intra-prediction. In contrast, in single loop decoding, the image value of a pixel level can be reconstructed in inter-layer intra-prediction, whereas only up to a residual signal can be reconstructed in inter-layer inter-prediction.

Accordingly, the single loop decoding mode is advantageous in that it has low complexity, but it cannot be applied to inter-layer intra-prediction because an enhancement layer has only a residual signal if the block of a corresponding reference layer has been reconstructed through inter-prediction when encoding and decoding the enhancement layer. That is, in SVC single loop decoding, a reference layer must be fully reconstructed in order to apply the SVC single loop decoding to inter-layer intra-prediction.

In this specification, there is proposed a method of performing inter-layer intra-prediction using an image value of a pixel level obtained through intra-prediction if a co-located block in neighboring frames within the same reference layer has an image value of a pixel level through intra-prediction although a corresponding reference layer has been reconstructed only up to a residual signal through inter-prediction when single loop decoding is used.

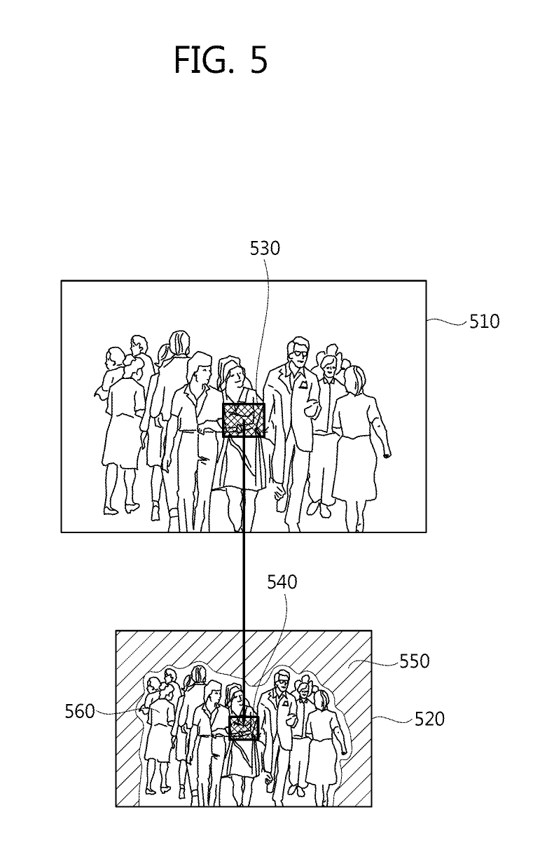

FIGS. 5 to 7 show images and are diagrams schematically illustrating contents in which inter-layer prediction is performed in accordance with the present invention.

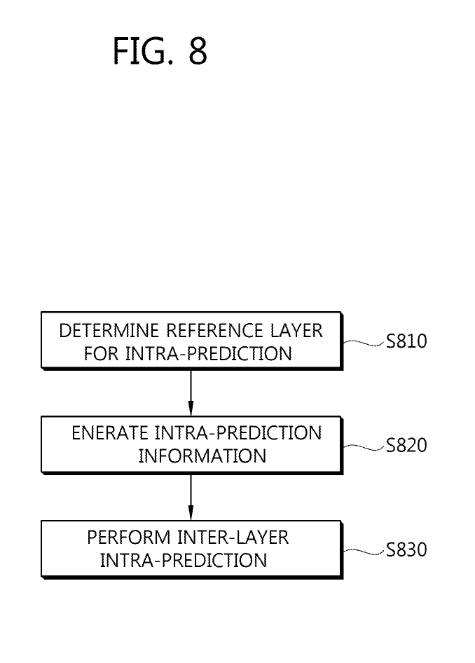

FIG. 8 is a flowchart schematically illustrating a method of performing inter-layer intra-prediction in accordance with the present invention.

The inter-layer intra-prediction method illustrated in FIG. 8 is described in detail below with reference to FIGS. 5 to 7.

Inter-layer intra-prediction, as described above, may be performed by the encoder and may be performed by the decoder. The following contents can be performed in the encoder and the decoder, unless specially described otherwise. It is assumed that inter-layer intra-prediction illustrated in FIG. 8 is performed by the inter-layer prediction module within the encoder or the decoder, for convenience of description.

Referring to FIG. 8, the inter-layer prediction module determines a reference layer for intra-prediction (S810).

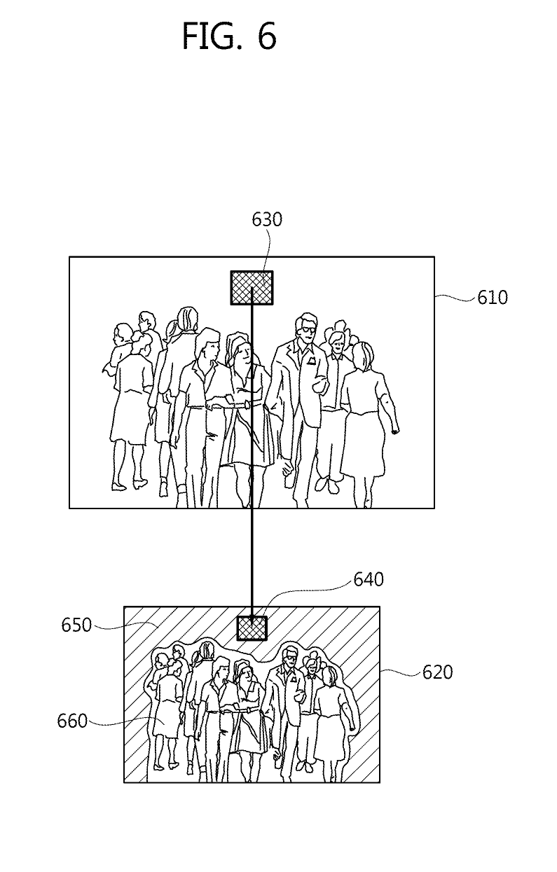

In the case of the single loop decoding mode, if a block 540 in a reference layer 520 that corresponds to a target prediction block 530 in a current layer 510 has been reconstructed through intra-prediction as in FIG. 5, that is, if the block 540 is located within an intra-prediction region 560 not within an inter-prediction region 550, inter-layer intra-prediction can be performed. In contrast, if a block 640 in a reference layer 620 that corresponds to a target prediction block 630 in a current layer 610 has been reconstructed through inter-prediction as in FIG. 6, that is, if the block 640 is located within an inter-prediction region 650 not within an intra-prediction region 660, inter-layer intra-prediction cannot be performed because only a residual signal is present.

If a block in a reference layer that corresponds to a block (i.e., a current block) in an enhancement layer (i.e., a current layer) that is now being encoded has been reconstructed through inter-prediction, the inter-layer prediction module searches for information for inter-layer intra-prediction.

For example, if only one reference layer is present, the inter-layer prediction module can perform inter-layer intra-prediction based on the one reference layer. If co-located blocks in neighboring frames in a reference layer that have already been encoded have image values through intra-prediction, the inter-layer prediction module can perform inter-layer intra-prediction using the image values. Here, in the case of B picture encoding/decoding, since all blocks on both sides (i.e., left and right) of a corresponding block in a reference layer on a time axis may have been intra-coded, the Rate-Distortion (hereinafter referred to as ‘RD’) cost of each block may be calculated and an inter-layer intra-prediction value may be then estimated using only one piece of information or through interpolation.

Furthermore, if a plurality of layers that can be referred is present and a block reconstructed through intra-prediction is included in the blocks of the plurality of layers that correspond to a target prediction block in a current layer, the inter-layer prediction module can use a layer included in the reconstructed block as a reference layer and perform inter-layer intra-prediction based on information about the corresponding block.

The inter-layer prediction module generates intra-prediction information from the determined reference layer (S820).

Even if a block in a layer(s) that corresponds to a current block has only a residual signal through inter-prediction, a reference layer for inter-layer intra-prediction can be determined through the step S810.

When the reference layer is determined, the inter-layer prediction module can obtain candidate values for intra-prediction from the determined reference layer.

If the number of blocks in a reference layer that correspond to a block (i.e., a current block) in an enhancement layer that is to be encoded/decoded is one or more, the inter-layer prediction module can inter-layer intra-prediction using a block reconstructed through intra-prediction, from among the blocks in the reference layer. If one or more blocks in a reference layer have been reconstructed through intra-prediction, an image value for the block of a reference layer, that is, the highest layer, can be used as a prediction value for inter-layer intra-prediction for a current block.

If the number of blocks in a reference layer that correspond to a block (i.e., a current block) in an enhancement layer to be now encoded/decoded is one and co-located blocks in before and after frames that have been encoded/decoded earlier than a corresponding reference frame in a reference layer on the same time axis include a block reconstructed through intra-prediction, inter-layer intra-prediction can be performed using the image value of the reconstructed block.

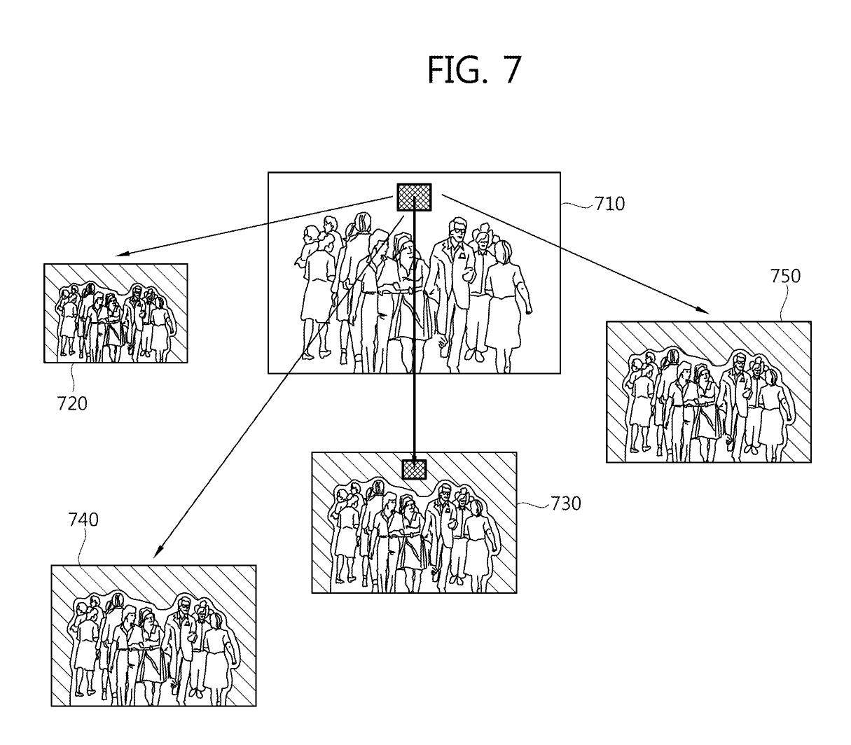

In the single loop decoding mode, if a corresponding block in a reference layer has only a residual signal through inter-prediction, a maximum of 4 inter-layer intra-prediction values can be obtained through the step S820 as in FIG. 7. For example, in FIG. 7, if a co-located block in a corresponding frame 730 in a reference layer that corresponds to a target prediction block in a current layer 710 has been inter-predicted, information for inter-layer intra-prediction can be obtained from frames 740 and 750 located anterior and posterior to the corresponding frame 730 in the reference layer. Furthermore, another prediction candidate 760 may be obtained by averaging the prediction values of the two frames 740 and 750.

The inter-layer prediction module performs inter-layer intra-prediction on a target prediction block in a current layer based on the obtained intra-prediction information (S830).

In the single loop decoding mode, if a corresponding block in a reference layer has only a residual signal through inter-prediction, a maximum of 4 inter-layer intra-prediction values can be obtained through the steps S810 and S820.

Accordingly, the inter-layer prediction module can determine optimum inter-layer intra-prediction mode based on a maximum of four prediction values. For example, the inter-layer prediction module can select prediction mode using any of a maximum of the four prediction values. In this case, the inter-layer prediction module can calculate an RD cost, etc. and determine optimum prediction mode based on the RD cost, etc. Here, information about which prediction mode will be used may be transmitted from the encoder to the decoder through a reference indicator. The reference indicator may include information about which frame will be used in a reference layer. The inter-layer prediction module of the decoder may perform inter-layer intra-prediction on a target prediction block in a current layer in prediction mode that is indicated by the reference indicator.

Unlike in an existing method, if information about which prediction mode will be used is transferred through a reference indicator, this can be taken into consideration even in a process for calculating an RD cost. For example, if a block in a reference layer has been encoded through inter-prediction, but the block has been determined as an optimum block to be used in inter-layer intra-prediction through the aforementioned method, the encoder calculates an RD cost including an indicator for the reference layer and determines mode having the smallest value as mode for inter-layer intra-prediction. Or, the encoder may calculate an RD cost including a reference frame indicator regarding what reference picture (frame) has been used in one reference layer and determine mode having the smallest value as mode for inter-layer intra-prediction.

In the aforementioned description, inter-layer intra-prediction has been illustrated as being performed by the inter-layer prediction module within the encoder or the decoder, but this is for convenience of description. Inter-layer intra-prediction may be performed through the elements of the encoder and the decoder described with reference to FIGS. 1 and 2. For example, the intra-prediction modules 120 and 240 described with reference to FIGS. 1 and 2 may perform inter-layer intra-prediction and the motion compensation modules 112 and 250 may perform inter-layer inter-prediction, such as inter-layer motion compensation. In this case, the inter-layer intra-prediction performed by the intra-prediction modules 120 and 240 and the inter-layer inter-prediction performed by the motion compensation modules 112 and 250 may include a process necessary for inter-layer prediction, such as up-sampling.

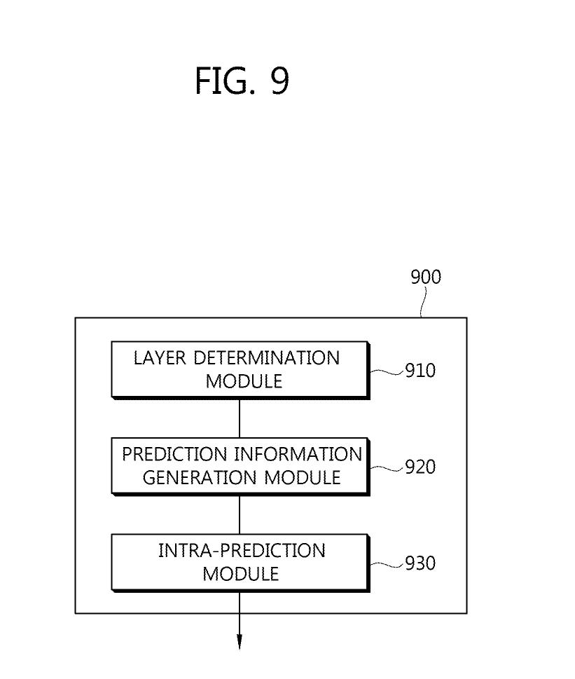

FIG. 9 is a block diagram schematically illustrating the construction of a prediction apparatus for performing inter-layer intra-prediction in accordance with the present invention.

Referring to FIG. 9, the inter-layer intra-prediction apparatus 900 includes a layer determination module 910, a prediction information generation module 920, and an intra-prediction module 930.

The layer determination module 910 determines a reference layer that can be used in inter-layer intra-prediction. For example, the layer determination module 910 can determine the highest layer as a reference layer if the number of layers that can be used as a reference layer in inter-layer intra-prediction on a current block in a current layer, for example, an enhancement layer is plural.

The prediction information generation module 920 generates intra-prediction information from the reference layer. For example, if a co-located block has been inter-predicted in a frame (i.e., a co-located frame) in a reference layer on a time axis that corresponds to a frame to which a target prediction block in a current layer belongs, the prediction information generation module 920 can generate intra-prediction information based on an intra-predicted and co-located block, from among frames anterior and posterior to the co-located frame.

More particularly, the prediction information generation module 920 can generate intra-prediction information about a target prediction block in a current layer as described in the steps S810 and S820 of FIG. 8. For example, if an intra-predicted and co-located block is not present in a corresponding frame in a reference layer, intra-prediction information can be generated from a co-located block that belongs to frames anterior and posterior to the corresponding frame. A co-located reference block may be additionally generated by interpolating or averaging video information about a co-located block in before and after frames, if necessary. The prediction information generation module 920 may determine which reference block will be used based on the RD cost of each reference block.

The intra-prediction module 930 can perform inter-layer intra-prediction on a target prediction block in a current layer based on the intra-prediction information generated by the prediction information generation module 920.

Although the inter-layer intra-prediction apparatus has been illustrated as additional module, the present invention is not limited thereto. For example, inter-layer intra-prediction elements 910, 920, and 930 may be included in the intra-prediction module of the enhancement layer encoder/decoder and may be included in the inter-layer prediction module that exists between the enhancement layer encoder/decoder and the base layer encoder/decoder.

Furthermore, in the present invention, intra-prediction information can include prediction mode, a prediction value, video information, etc. that are used in intra-prediction.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, the aforementioned embodiments include various aspects of examples. For example, a combination of the embodiments should also be understood as an embodiment of the present invention.

1. An inter-layer intra-prediction method according to a single loop decoding mode, comprising steps of:
determining a reference layer for inter-layer intra-prediction;
generating intra-prediction information from the reference layer; and
performing inter-layer prediction on a current block based on the intra-prediction information,
wherein if a co-located block of a reference frame corresponding to a target prediction frame in the reference layer on a time axis has been inter-predicted, the intra-prediction information is generated based on an intra-predicted and co-located block, from among frames anterior and posterior to the reference frame.

2. The inter-layer intra-prediction method of claim 1, wherein if at least one candidate layer that is able to be referred for the inter-layer intra-prediction exists and a co-located block in the candidate layer has been inter-predicted, the intra-prediction information is generated from the intra-predicted and co-located block, from among the frame anterior and posterior to a frame in which the co-located block is present on the candidate layer.

3. The inter-layer intra-prediction method of claim 1, wherein if candidate layers that are able to be referred for the inter-layer intra-prediction, the intra-prediction information is generated from an intra-predicted block from among co-located blocks in the candidate layers.

4. The inter-layer intra-prediction method of claim 3, wherein if a plurality of intra-predicted blocks is included in the co-located blocks of the candidate layers, a candidate layer of a highest layer is selected as the reference layer and the intra-prediction information is generated from an intra-predicted and co-located block in the selected reference layer.

5. The inter-layer intra-prediction method of claim 1, wherein if a plurality of intra-predicted and co-located blocks is included in frames anterior and posterior to a frame to which a reference block belongs, the intra-prediction information is generated from a co-located block having a minimum Rate-Distortion (RD) cost.

6. The inter-layer intra-prediction method of claim 1, wherein the intra-prediction information is generated from a co-located block having a minimum RD cost, from among a first co-located block of a first frame that is temporally anterior to a frame to which a reference block belongs and has been intra-prediction, a second co-located block of a second frame that is temporally posterior to the frame to which the reference block belongs and has been intra-predicted, and a third co-located block obtained by averaging image values of the first co-located block and the second co-located block.

7. The inter-layer intra-prediction method of claim 1, wherein the intra-prediction information is obtained from a co-located block having a minimum RD cost, from among a first co-located block of a first frame that is temporally anterior to a frame to which a reference block belongs and has been intra-prediction, a second co-located block of a second frame that is temporally posterior to the frame to which the reference block belongs and has been intra-predicted, and a third co-located block generated by interpolation based on the first co-located block and the second co-located block.

8. An inter-layer intra-prediction apparatus according to a single loop decoding mode, comprising:
a layer determination module determining a reference layer for inter-layer intra-prediction;
a prediction information generation module generating intra-prediction information from the reference layer; and
an intra-prediction module performing inter-layer prediction on a current block based on the intra-prediction information,
wherein if a co-located block of a reference frame corresponding to a target prediction frame in the reference layer on a time axis has been inter-predicted, the prediction information generation module generates the intra-prediction information based on an intra-predicted and co-located block, from among frames anterior and posterior to the reference frame.

9. The inter-layer intra-prediction apparatus of claim 8, wherein if a candidate layer that is able to be referred for the inter-layer intra-prediction is one or more and a co-located block in the candidate layer has been inter-predicted, the prediction information generation module generates the intra-prediction information from the intra-predicted and co-located block, from among the frame anterior and posterior to a frame in which the co-located block is present on the candidate layer.

10. The inter-layer intra-prediction apparatus of claim 8, wherein if at least one candidate layer that is able to be referred for the inter-layer intra-prediction exists, the prediction information generation module generates the intra-prediction information from an intra-predicted block from among co-located blocks in the candidate layers.

11. The inter-layer intra-prediction apparatus of claim 10, wherein if a plurality of intra-predicted blocks is included in the co-located blocks of the candidate layers,
the layer determination module selects a candidate layer of a highest layer as the reference layer, and
the prediction information generation module generates the intra-prediction information from an intra-predicted and co-located block in the selected reference layer.

12. The inter-layer intra-prediction apparatus of claim 8, wherein if a plurality of intra-predicted and co-located blocks is included in frames anterior and posterior to a frame to which a reference block belongs,
the prediction information generation unit generates the intra-prediction information from a co-located block having a minimum Rate-Distortion (RD) cost.

13. The inter-layer intra-prediction apparatus of claim 8, wherein the prediction information generation unit generates the intra-prediction information from a co-located block having a minimum RD cost, from among a first co-located block of a first frame that is temporally anterior to a frame to which a reference block belongs and has been intra-prediction, a second co-located block of a second frame that is temporally posterior to the frame to which the reference block belongs and has been intra-predicted, and a third co-located block obtained by averaging image values of the first co-located block and the second co-located block.

14. The inter-layer intra-prediction apparatus of claim 8, wherein the prediction information generation module obtains the intra-prediction information from a co-located block having a minimum RD cost, from among a first co-located block of a first frame that is temporally anterior to a frame to which a reference block belongs and has been intra-prediction, a second co-located block of a second frame that is temporally posterior to the frame to which the reference block belongs and has been intra-predicted, and a third co-located block generated by interpolation based on the first co-located block and the second co-located block.
